(19) United States
(12) Patent Application Publication
(10) Pub. No.: US 2024/0273383 A1
(43) Pub. Date: Aug. 15, 2024

(54) METHODS AND SYSTEMS FOR ENHANCING ASSET RESOURCE RESILIENCY

(71) Applicant: Commonwealth Edison Company, Chicago, IL (US)

(72) Inventors: Shikhar Pandey, Forest Park, IL (US); William I. Nation, Elmhurst, IL (US); Aleksandar Vukojevic, Harrisburg, NC (US); Sai Siddharth Reddy Kandimalla, Chicago, IL (US); Melany Gutierrez-Hernandez, Chicago, IL (US)

(21) Appl. No.: 18/168,216

(22) Filed: Feb. 13, 2023

(51) Int. Cl. G06N 5/022; G01W 1/06

(52) U.S. Cl. CPC G06N 5/022; G01W 1/06

(57) ABSTRACT

Methods, systems, and apparatuses for predicting an estimate of a number of equipment outages affected by severe weather events. Resource data associated with weather data and equipment data may be used to train a predictive model. The predictive model may be trained to output a prediction indicative of a number of equipment outages associated with an area affected by a severe weather event.

### BACKGROUND

Severe weather events have the potential to adversely affect utility services, causing dramatic changes in the number of interruptions and restoration times compared to an average day. For example, from 2002 to 2022, roughly 390 severe events were reported associated with weather in the Midwestern region of the United States. Unreliable utility services can lead to long-term socio-economic effects such as damaged infrastructure, loss of businesses, and excessive recovery costs for the utilities due to the need of deploying additional crews and resources to restore the utility outage. In addition, utility outages can also disrupt the life and activities of citizens, in addition to their health and/or security, especially due to the increased reliance on the use of electric devices or communication systems for securing a home or determining important health conditions. For example, in August 2020, a derecho storm caused 5,649 power outages affecting 793,083 citizens in the Midwest. Therefore, accurate equipment outage predictions associated with utility systems are necessary in order to proactively prepare for these severe weather events and improve utility system resilience. Reducing the response time and enabling the efficient deployment of crews and resources to areas severely affected by severe weather events can accelerate infrastructure recovery and minimize the social and financial costs of these severe weather events.

However, one of the biggest issues facing the use of machine learning is the lack of availability of large, annotated datasets. The annotation of data is not only expensive and time consuming but also highly dependent on the availability of expert observers. The limited amount of training data can inhibit the performance of supervised machine learning algorithms which often need very large quantities of data on which to train to avoid overfitting. So far, much effort has been directed at extracting as much information as possible from what data is available. One area in particular that suffers from lack of large, annotated datasets is the analysis of severe weather events and the relationship between these severe weather events and the outages caused to utility services by these severe weather events. The ability to analyze severe weather events and their effects on utility services to predict equipment outages is critical to the efficient deployment of crews and resources to respond to damages, or outages, causes by these severe weather events. However, in many instances, insufficient data are available to train machine learning algorithms to accurately predict the equipment outages caused by these severe weather events.

### SUMMARY

It is to be understood that both the following general description and the following detailed description are exemplary and explanatory only and are not restrictive.

In an embodiment, disclosed are methods comprising determining, by a computing device, resource data associated with weather data and equipment data, wherein the resource data comprises one or more groups of resource characteristics, wherein each group of resource characteristics of the one or more groups of resource characteristics is labeled according to a predefined feature of a plurality of predefined features, determining, based on the resource data, a plurality of features for a predictive model, training, based on a first portion of the resource data, the predictive model according to the plurality of features, testing, based on a second portion of the resource data, the predictive model, and outputting, based on the testing, the predictive model.

In an embodiment, disclosed are methods comprising determining, based on the weather data and the equipment data, one or more resource data sets that comprise one or more groups of one or more weather data characteristics and one or more equipment data characteristics, and generating, based on the one or more resource data sets, the resource data.

In an embodiment, disclosed are methods comprising determining baseline feature levels for each group of resource characteristics of the one or more groups of resource characteristics, labeling the baseline feature levels for each group of resource characteristics of the one or more groups of resource characteristics as at least one predefined feature of the plurality of predefined features, and generating, based on the labeled baseline feature levels, the resource data.

In an embodiment, disclosed are methods comprising receiving, at a computing device, resource data associated with weather data associated with a weather pattern affecting a geographic area and equipment data associated with one or more equipment components in the geographic area, providing, to a predictive model, the resource data, and determining, based on the predictive model, a prediction indicative of a total equipment outage associated with the geographic area.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows an example system;

FIG. 2 shows an example process;

FIG. 3 shows a flowchart of an example method;

FIG. 4 shows an example machine learning system;

FIG. 5 shows a flowchart of an example machine learning method;

FIG. 6 shows an example computer system for implementing the machine learning system;

FIG. 7 shows a flowchart of an example method; and

FIG. 8 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, the methods and systems may take the form of a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Methods and systems are described for generating a machine learning classifier for a prediction indicative of a number of equipment outages associated with a geographic area affected by a weather event. For example, the equipment outages may be associated with one or more services (e.g., electricity service, gas service, water service, telecommunication service, etc.) affected by the weather event. Machine learning (ML) is a subfield of computer science that gives computers the ability to learn without being explicitly programmed. Machine learning platforms include, but are not limited to, naïve Bayes classifiers, support vector machines, decision trees, neural networks, and the like.

In an example, resource data may be received. The resource data may comprise weather data and equipment data. The weather data may comprise a storm classifier indicative of a windstorm, a thunderstorm, a hurricane, a cyclone, a blizzard, an ice storm, or a snow storm. The storm classifier may be associated with one or more storm attributes associated with an affected geographic area. For example, the storm attributes may comprise one or more of maximum winds, maximum gusts, lightning, maximum rain, maximum snow, maximum temperature, minimum temperature, or average temperature of an affected geographic area. The equipment data may comprise data indicative of one or more equipment components in a geographic area associated with the weather data. For example, the equipment data may comprise data indicative one or more equipment components affected by a weather event, wherein the weather event may be associated with the weather data. The machine learning classifier, or predictive model, may be trained using the resource data associated with the weather data and the equipment data. The predictive model may output a prediction indicative of a number of equipment outages associated with a geographic area. As an example, the prediction of the number of equipment outages may be used to increase the resilience of the affected area through more accurate planning and increase the accuracy with respect to estimating the time to restoration of one or more utility services. For example, proactive measures may be taken, based on the prediction, to optimize resources to minimize the damages caused to the equipment in the affected geographical area. For example, a Customer Average Interruption Duration Index (CAIDI) may be determined based on the equipment outage prediction (e.g., number, and/or duration, of equipment outages). The CAIDI may comprise an average outage duration that any given customer may experience in an affected geographical area, or the average time required to restore service to the average customer of the affected geographical area. For example, the CAIDI may be determined based on a number of resources (e.g., crews, equipment, etc.) estimated to address the predicted equipment outages.

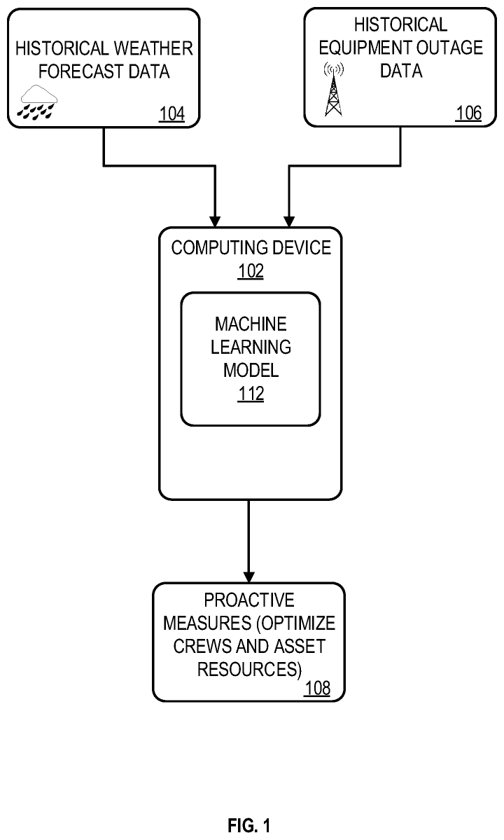

FIG. 1 shows a system 100 that may be configured for determining a number of equipment outages associated with a geographical area affected by a weather event. The weather event may comprise one or more of a windstorm, a thunderstorm, a hurricane, a cyclone, a blizzard, an ice storm, or a snow storm. As an example, the number of equipment outages may be associated with one or more equipment components in the geographical area affected by the weather event. As an example, the number of equipment outages may be associated with one or more utility services (e.g., electricity service, gas service, water service, telecommunication service, etc.) associated with the geographic area affected by the weather event. Machine learning and/or artificial intelligence may be used to predict the number of equipment outages associated with the geographic area affected by the weather event based on resource data associated with the geographical area.

As shown in FIG. 1, the system 100 may comprise a computing device 102 (e.g., a user device, a server, a cloud device, a central computing device, etc.). The computing device 102 may be associated with a service/utility provider and/or a utility management system. The computing device 102 may be configured at (or disposed at) a central location (e.g., a headend, a processing facility, a service/utility provider, etc.) and may be configured to receive the resource data from a variety of sources. As an example, the computing device 102 may receive historical weather data 104 from one or more sources such as one or more databases associated with one or more utility service providers. For example, the historical weather data 104 may include utility data from the one or more utility service providers. The historical weather data 104 may comprise a storm classifier indicative of a windstorm, a thunderstorm, a hurricane, a cyclone, a blizzard, an ice storm, or a snow storm. The storm classifier may be associated with one or more weather characteristics of max winds, max gusts, lightning, max rain, max snow, max temp, min temp, average temp, or an affected geographic area. As an example, the computing device 102 may receive historical equipment outage data 106 from one or more sources such as one or more databases associated with one or more utility service providers. For example, the historical equipment outage data 106 may include utility data from the one or more utility service providers. The historical equipment outage data 106 may comprise data indicative of one or more equipment components in a geographic area associated with the weather data. In an example, the historical equipment outage data 106 may be indicative of one or more equipment characteristics comprising one or more of electrical service equipment, gas service equipment, water service equipment, or telecommunication service equipment. The historical weather data 104 and the historical equipment outage data 106 may be used to form one or more resource datasets. For example, the one or more resource datasets may comprise one or more groups of one or more weather data characteristics associated with the historical weather data 104 and one or more equipment data characteristics associated with the historical equipment outage data 106. The one or more datasets may comprise labeled data and/or target features (e.g., ordinal features, nominal features, etc.) associated with equipment outages in a geographical area affected by a weather event.

The one or more datasets may be provided as inputs to a machine learning model 112. The machine learning model 112 may be trained based on the inputs in order to predict equipment outages (e.g., number and duration of equipment outages) of a geographical area affected by a weather event based on the datasets of the resource data.

The equipment outage predictions of the geographical area affected by the weather event produced by the machine learning model 112 may be output to one or more utility/service providers of the affected geographical area to enable the one or more utility/service providers to take proactive measures 108 to optimize crews and asset resources to minimize the damages caused to the equipment in the geographical area. For example, the proactive measures 108 may comprise crew positioning, an optimal number of crews or crew members (e.g., field technicians), asset positioning (e.g., trucks, service drones, etc.), or positioning of mobile generators. The ability to efficiently predict equipment outages due to one or more weather events can minimize recovery operational costs and restoration time of services affected by the one or more equipment outages. This increases the resilience of the affected areas through more accurate planning and a more accurate estimation of the time to restoration. For example, a Customer Average Interruption Duration Index (CAIDI) may be determined based on the equipment outage prediction (e.g., number and duration of equipment outages). The CAIDI may comprise an average outage duration that any given customer may experience in an affected geographical area, or the average time required to restore service to the average customer of the affected geographical area. For example, the CAIDI may be determined based on a number of resources (e.g., crews, equipment, etc.) estimated to address the predicted equipment outages.

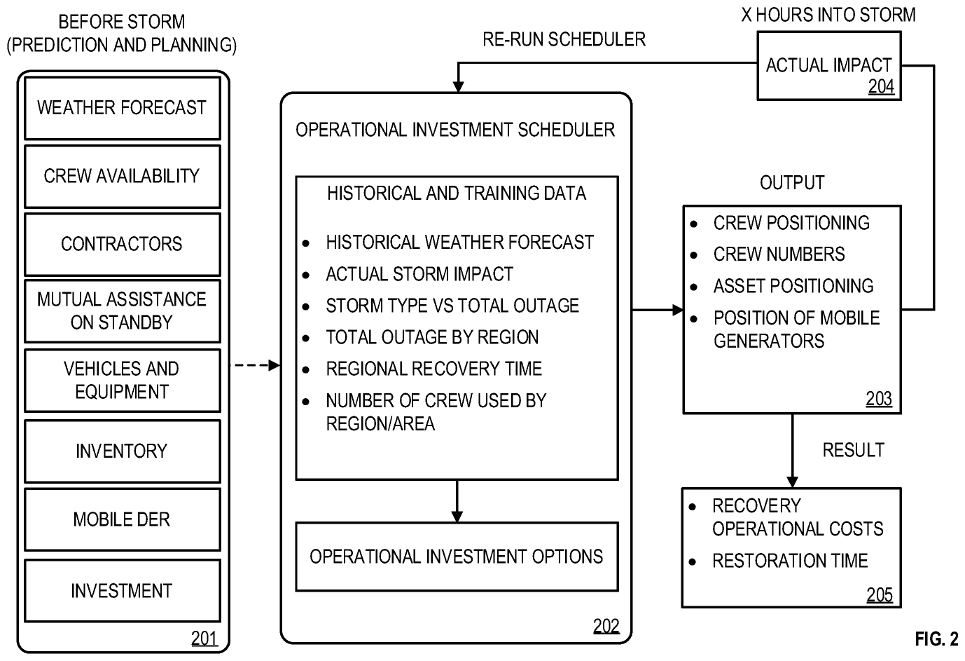

FIG. 2 shows an example process that uses the prediction indicative of the number of equipment outages associated with a geographical area affected by a weather event. At 201, prior to the weather event, pre-storm planning of resources may be performed. For example, a utility/service provider of a potentially affected geographic area may be perform pre-storm planning activities associated with available resources. For example, prediction and planning information such as weather forecast information, crew availability information, local contractor information, mutual assistance information, vehicle and equipment information, inventory information, mobile distributed energy resource (DER) information, and/or investment information may be used to perform the pre-storm planning activities.

At 202, the prediction and planning information may be provided to an Operational Investment Scheduler for determining Historical and Training data. For example, the Historical and Training data may include historical weather forecast data, actual storm impact data, storm type versus total outage data, total equipment outage by region data, equipment outage duration by region data, count of customers outage by quipment, regional recovery time data, and/or data indicative of a number of crew used by region/area. For example, the Historical and Training data may include utility data from one or more utility service providers. For example, the Historical and Training data may comprise historical weather forecast data, actual storm impact data, storm type versus total outage data, total outage by region data, regional recovery time data, and/or number of crew used by region/area data. The Historical and Training data may be analyzed in order to determine Operational Investment Options. As an example, the historical weather forecast data (e.g., historical storm directory) may be compared to past storm data to find similarities in area recoveries. As an example, a crew efficiency assessment may be determined. For example, a scoring metric may be determined, wherein the scoring metric may provide an average efficiency of crews for each region for a given storm. This efficiency may be applied to a forecasted weather event to determine the number of crews required to address a particular weather event. For example, the crew efficiency may be calculated using the following formula:

$$\frac{\# Outages Restored}{\# FTE} * \frac{\# FTE}{Crew}$$

In an example, the crew efficiency metric may be determined for any given time frame within a given territory/region. As an example, the weather forecast data may be used to determine whether a storm classifier/weather parameter is significant enough to perform historical and training data analysis for making crew deployment recommendations. For example, if the storm classifier indicates a small weather event, it may not be necessary to further process the historical and training data in order to determine an equipment outage prediction. The expense/cost of analyzing the data and positioning crews may significantly outweigh the benefits of preparing for a small weather event. As an example, the Historical and Training data may be provided to a machine learning model, wherein the machine learning model may predict equipment outages (e.g., number and duration of equipment outages) associated with a geographical area affected by the weather event. The prediction may be used to determine the Operational Investment Options. In an example, a statistical outage prediction methodology may be used in combination with the machine learning model equipment outage prediction to determine Operational Investment Options. The statistical outage prediction methodology may utilize historical weather forecast data (e.g., historical storm directory dataset) to filter a dataset based on forecasted weather parameters and/or average outages and customers to determine (e.g., estimate, calculate, etc.) predicted outages and predicted customers.

At 203, the Operational Investment Scheduler may output information associated with the proactive measures that may be implemented based on the Operational Investment Options. For example, the proactive measures may include crew positioning, crew numbers, asset (e.g., trucks, service drones, service equipment, etc.) positioning and numbers, and positioning mobile generators. As an example, a crew time-to-release metric may be determined. For example, additional expenses may be incurred when external crews are utilized to aid an area in recovering from a weather event. Thus, external crews may be placed to assist equipment outages based on a time frame the external crews can complete certain necessary recovery efforts/tasks. The external crews may be released to work on additional areas affected by a weather event before the need for additional resources to accommodate the external crews while the external crews work on the designated recovery area. As an example, a Customer Average Interruption Duration Index (CAIDI) may be determined based on the equipment outage prediction (e.g., number and duration of equipment outages). The CAIDI may comprise an average outage duration that any given customer may experience in an affected geographical area, or the average time required to restore service to the average customer of the affected geographical area. For example, the CAIDI may be determined based on a number of resources (e.g., crews, equipment, etc.) estimated to address the predicted equipment outages. Areas with high CAIDI may be invested in first, and thus, lowering the overall CAIDI for the corresponding areas.

At 204, after a predetermined time duration (e.g., X hours into a weather event), data based on the actual weather event may be input into the Operational Investment Scheduler and the Operational Investment Scheduler may be re-run with the actual weather event information. For example, crew allocations and crew re-allocations may be analyzed, wherein crew efficiency associated with regions may be tracked for a plurality of time periods (e.g., daily, weekly, monthly, according to crew shifts, etc.). In an example, for larger weather events, a reduction in crew efficiency may be observed between one or more time periods (e.g., between shifts, from one day to the next, etc.) as a percentage of crews are moved from one region to another. For example, if a region is experiencing a certain level of improvement within a certain time frame, a reduction in crew efficiency may be determined due to a few remaining outages in the affected area, wherein crews may be moved to another region that is experiencing a higher number of remaining outages. In an example, based on initial equipment outages from the weather event, one or more predictions of a time duration associated fully recovering from the weather event may be determined based on the historical weather forecast data (e.g., historical storm directory).

At 205, the results of the proactive measures implemented during the weather event may be determined. In an example, recovery operational costs and restoration time(s) may be determined. In an example, a financial analysis may be performed to determine the cost incurred (e.g., proportional to the resources deployed) versus the CAIDI (e.g., total outage and total outage duration). For example, the costs incurred may be determined based on the CAIDI and the predicted number of equipment outages. For example, a crew efficiency metric may be used to determine a number of crews that may be necessary (e.g., required) to respond to outages in a particular affected area/region. Based on the equipment outage prediction, a standard crew count may be used to determine a cost incurred for a particular outage. Labor may be optimized to reduce crew travel time and crew type (e.g., internal crew, local crew, external crew, etc.).

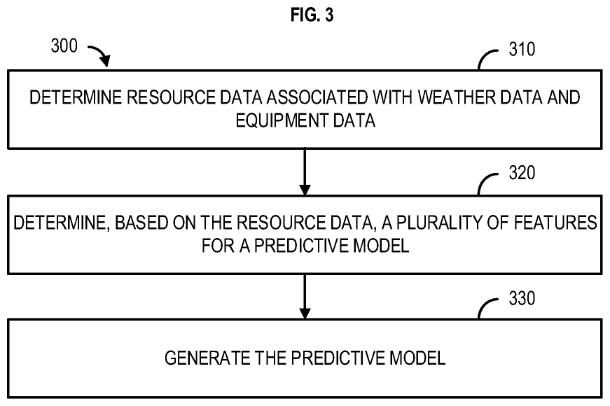

FIG. 3 shows a flowchart of an example method 300 for generating a predictive model comprising receiving resource data associated with weather data and equipment data at 310, determining, based on the resource data, a plurality of features for a predictive model at 320, and generating, based on the plurality of features, a predictive model at 330.

Determining the resource data associated with the weather data and the equipment data at 310 may comprise downloading/obtaining/receiving weather data sets and equipment data sets, obtained from various sources, including recent publications and/or publically available databases. For example, the weather data sets and the equipment data sets may be obtained from one or more sources such as one or more databases associated with one or more utility/service providers. For example, the weather data sets and the equipment data sets may include utility data from the one or more utility/service providers. The weather data may comprise a storm classifier indicative of a windstorm, a thunderstorm, a hurricane, a cyclone, a blizzard, an ice storm, or a snow storm. The storm classifier may be associated with one or more storm characteristics of max winds, max gusts, lightning, max rain, max snow, max temp, min temp, average temp, or an affected geographic area. The equipment data may comprise data indicative of one or more equipment components in a geographic area associated with the weather data.

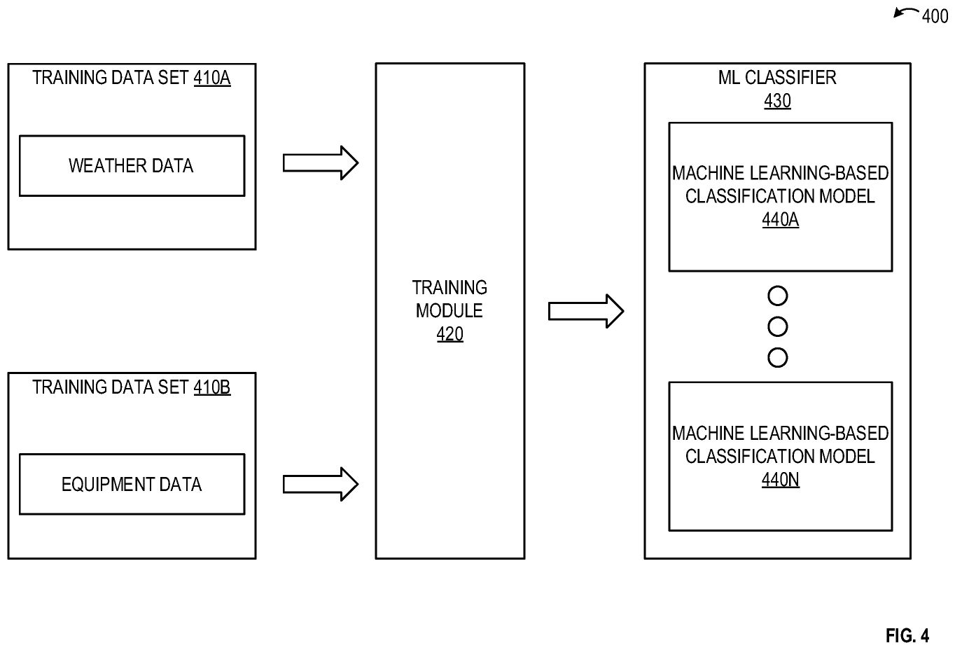

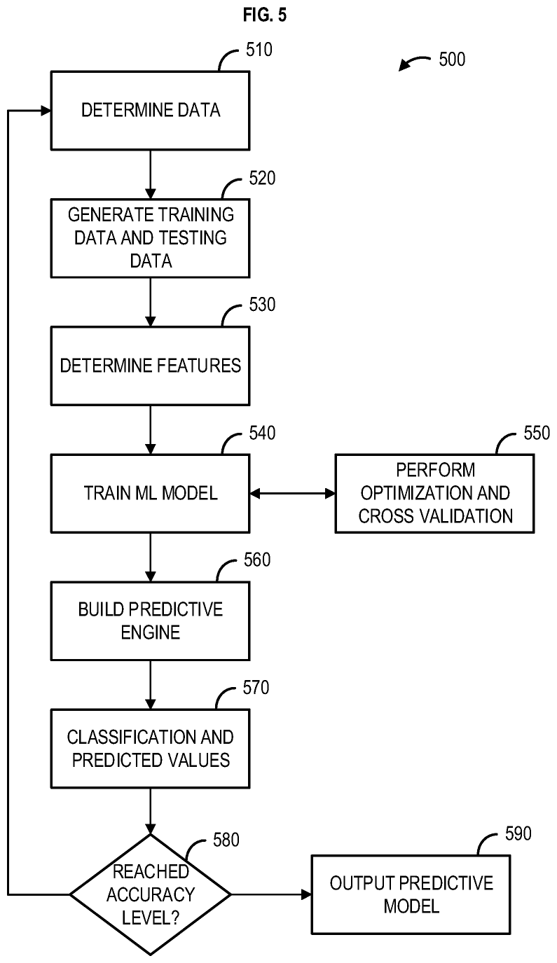

Determining, based on the resource data, a plurality of features for a predictive model at 320 and generating, based on the plurality of features, a predictive model at 330 are described with regard to FIG. 4 and FIG. 5.

A predictive model (e.g., a machine learning classifier) may be generated to provide a prediction indicative of a number of equipment outages associated with a geographic area. The prediction may be used to enable one or more utility/service providers to take proactive measures to optimize crews and asset resources to minimize the damages caused to the equipment in the geographical area affected by a weather event. The predictive model may be trained according to the resource data (e.g. one or more resource data sets and/or baseline feature levels) associated with weather data and equipment data. The baseline feature levels may relate to one or more groups of resource characteristics, wherein each group of resource characteristics may be associated with one or more weather data characteristics and one or more equipment data characteristics. The one or more weather data characteristics may be associated with one or more storm characteristics of max winds, max gusts, lightning, max rain, max snow, max temp, min temp, average temp, or an affected geographic area. The one or more equipment data characteristics may be associated with one or more of electrical service equipment, gas service equipment, water service equipment, or telecommunication service equipment. In an example, one or more features of the predictive model may be extracted from one or more of the resource data sets and/or the baseline feature levels.

FIG. 4 shows a system 400 that is configured to use machine learning techniques to train, based on an analysis of one or more training data sets 410A-410B by a training module 420, at least one machine learning-based classifier 430 that is configured to classify expected equipment outage results. As an example, the training data sets 410A-410B may comprise one or more resource data sets. For example, the one or more resource data sets may comprise the one or more groups of weather data characteristics and the one or more equipment data characteristics. As an example, the training data set 410A (e.g., the weather data) may comprise one or more weather data sets and the training data set 410B (e.g., the equipment data) may comprise one or more equipment data sets. As an example, the training data sets 410A-410B may comprise labeled baseline feature levels. The labels may comprise a plurality of predefined features associated with the one or more weather data characteristics and/or the one or more equipment data characteristics.

The training module 420 may train the machine learning-based classifier 430 by extracting a feature set from the resource data (e.g., one or more resource data sets and/or baseline feature levels) in the training data set 410 according to one or more feature selection techniques.

In an example, the training module 420 may extract a feature set from the training data set 410A and the training data set 410B in a variety of ways. The training module 420 may perform feature extraction multiple times, each time using a different feature-extraction technique. As an example, the feature sets generated using the different techniques may each be used to generate different machine learning-based classification models 440. As an example, the feature set with the highest quality metrics may be selected for use in training. The training module 420 may use the feature set(s) to build one or more machine learning-based classification models 440A-440N that are configured to indicate whether or not new data is associated with a number of equipment outages.

In an example, the training data sets 410A-410B may be analyzed to determine one or more groups of resource characteristics that have at least one feature that may be used to predict the a number of equipment outages. As an example, the at least one feature may comprise one or more characteristics associated with one or more weather data characteristics and one or more equipment data characteristics. The one or more weather data characteristics may comprise one or more of max winds, max gusts, lightning, max rain, max snow, max temp, min temp, average temp, or an affected geographic area. The one or more equipment data characteristics may comprise one or more of electrical service equipment, gas service equipment, water service equipment, or telecommunication service equipment. The one or more groups of resource characteristics may be considered as features (or variables) in the machine learning context. The term “feature,” as used herein, may refer to any characteristic of a group of resource data that may be used to determine whether the group of resource characteristics fall within one or more specific categories.

In an example, a feature selection technique may comprise one or more feature selection rules. The one or more feature selection rules may comprise a resource characteristic occurrence rule. In an example, the one or more feature selection rules may comprise a weather data characteristic and an equipment data characteristic occurrence rule. The resource characteristic occurrence rule may comprise determining which resource characteristics, or group of resource characteristics, in the training data sets 410A-410B occur over a threshold number of times and identifying those resource characteristics that satisfy the threshold as candidate features. For example, any resource characteristic, or group of resource characteristics, that appear greater than or equal to 50 times in the training data sets 410A-410B may be considered as candidate features. Any resource characteristic, or group of resource characteristics, appearing less than 50 times may be excluded from consideration as a feature.

In an example, the one or more feature selection rules may comprise a significance rule. The significance rule may comprise determining, from the baseline feature level data in the training data sets 410A-410B, resource characteristic data, wherein the resource characteristic data includes one or more weather data characteristics and one or more equipment data characteristics. As the baseline feature level in the training data sets 410A-410B are labeled according to one or more resource characteristics, the labels may be used to determine the resource characteristic data.

In an example, a single feature selection rule may be applied to select features or multiple feature selection rules may be applied to select the features. For example, the feature selection rules may be applied in a cascading fashion, with the feature selection rules being applied in a specific order and applied to the results of the previous rule. For example, the resource characteristic occurrence rule may be applied to the training data sets 410A-410B to generate a first list of features. The significance rule may be applied to features in the first list of features to determine which features of the first list satisfy the significance rule in the training data sets 410A-410B and to generate a final list of candidate features.

The final list of candidate features may be analyzed according to additional feature selection techniques to determine one or more candidate feature signatures (e.g., groups of resource characteristics that may be used to predict a number of equipment outages). Any suitable computational technique may be used to identify the candidate feature signatures using any feature selection technique such as filter, wrapper, and/or embedded methods. In an example, one or more candidate feature signatures may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable (e.g., an expected equipment outage result).

In an example, one or more candidate feature signatures may be selected according to a wrapper method. A wrapper method may be configured to use a subset of features and train a machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. As an example, forward feature selection may be used to identify one or more candidate feature signatures. Forward feature selection is an iterative method that begins with no feature in the machine learning model. In each iteration, the feature which best improves the model is added until an addition of a new variable does not improve the performance of the machine learning model. As an example, backward elimination may be used to identify one or more candidate feature signatures. Backward elimination is an iterative method that begins with all features in the machine learning model. In each iteration, the least significant feature is removed until no improvement is observed on removal of features. As an example, recursive feature elimination may be used to identify one or more candidate feature signatures. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

In an example, one or more candidate feature signatures may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to the absolute value of the magnitude of coefficients and ridge regression performs L2 regularization which adds a penalty equivalent to the square of the magnitude of coefficients.

After the training module 420 has generated a feature set(s), the training module 420 may generate a machine learning-based classification model 440 based on the feature set(s). The machine learning-based classification model 440, may refer to a complex mathematical model for data classification that is generated using machine-learning techniques. In an example, this machine learning-based classifier may include a map of support vectors that represent boundary features. For example, boundary features may be selected from, and/or represent the highest-ranked features in, a feature set.

In an example, the training module 420 may use the feature sets extracted from the training data sets 410A-410B to build a machine learning-based classification model 440A-440N for each classification category (e.g., equipment outage prediction). In an example, a plurality of machine learning-based classification models 440A-440N may be used for each classification category (e.g., equipment outage prediction). For example, an automatic recognition model/algorithm may be used to determine the final machine learning model. For example, the equipment outage prediction may be determined for each machine learning-based classification model 440A-440N. The final machine learning model may be determined based on the machine learning model with the most accurate prediction of the previous weather event. In an example, the machine learning-based classification models 440A-440N may be combined into a single machine learning-based classification model 440. Similarly, the machine learning-based classifier 430 may represent a single classifier containing a single or a plurality of machine learning-based classification models 440 and/or multiple classifiers containing a single or a plurality of machine learning-based classification models 440.

The extracted features (e.g., one or more candidate features and/or candidate feature signatures derived from the final list of candidate features) may be combined in a classification model trained using a machine learning approach such as discriminant analysis; decision tree; extreme gradient boosting (XGBoost); ensemble regression (ENS); a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 430 may comprise a decision rule or a mapping that uses the expression levels of the features in the candidate feature signature to predict a number of equipment outages associated with a geographic area affected by a weather event.

The candidate feature signature and the machine learning-based classifier 430 may be used to provide a prediction indicative of a number of equipment outages in the testing data sets 410A-410B. In an example, the result for each test includes a confidence level that corresponds to a likelihood or a probability that the corresponding test predicted a number of equipment outages. The confidence level may be a value between zero and one that represents a likelihood that the corresponding test is associated with a number of equipment outages. In one example, when there are two or more statuses (e.g., two or more expected equipment outage results), the confidence level may correspond to a value p, which refers to a likelihood that a particular test is associated with a first status. In this case, the value 1−p may refer to a likelihood that the particular test is associated with a second status. In general, multiple confidence levels may be provided for each test and for each candidate feature signature when there are more than two statuses. A top performing candidate feature signature may be determined by comparing the result obtained for each test with known expected equipment outage results for each test. In general, the top performing candidate feature signature will have results that closely match the known number of equipment outages.

The top performing candidate feature signature may be used to predict the expected number of equipment outages. For example, resource data and/or baseline feature data may be determined/received. The resource data and/or the baseline feature data may be provided to the machine learning-based classifier 430 which may, based on the top performing candidate feature signature, predict/determine an expected number of equipment outages result. Based on the predicted/determined number of equipment outages associated with a geographic area affected by a weather event, a utility/service provider may deploy crews and/or asset resources to the affected area. For example, the utility/service provider may take proactive measures to optimize the number of crews and asset resources needed based on the equipment outage prediction. For example, the proactive measures may comprise crew positioning, an optimal number of crews or crew members (e.g., field technicians), asset positioning (e.g., trucks, service drones), or positioning of mobile generators. The ability to efficiently predict equipment outages due to one or more weather events can minimize recovery operational costs and restoration time of services affected by the one or more equipment outages. This increases the resilience of the affected areas through more accurate planning and a more accurate estimation of the time to restoration.

FIG. 5 shows a flowchart of an example training method 500 for generating the machine learning-based classifier 430 using the training module 420. The training module 420 may be implement using supervised, unsupervised, and/or semi-supervised (e.g., reinforcement based) machine learning-based classification models 440. The method 500 shown in FIG. 5 is an example of a supervised learning method; variations of this example of training method are discussed below, however, other training methods may be analogously implemented to train unsupervised and/or semi-supervised machine learning models.

The training method 500 may determine (e.g., access, receive, retrieve, etc.) resource data associated with weather data and equipment data at 510. The resource data may contain one or more datasets, wherein each dataset may be associated with a particular study. Each study may involve historical data from one or more utility/service providers, although it is contemplated that some study overlap may occur. In an example, each dataset may include a labeled list of predetermined features. As an example, the labels may be associated with one or more resource characteristics. As an example, the labels may be associated with one or more weather data characteristics and one or more equipment data characteristics. The one or more weather data characteristics may comprise one or more of max winds, max gusts, lightning, max rain, max snow, max temp, min temp, average temp, or an affected geographic area. The one or more equipment data characteristics may comprise one or more of electrical service equipment, gas service equipment, water service equipment, or telecommunication service equipment.

The training method 500 may generate, at 520, a training data set and a testing data set. The training data set and the testing data set may be generated by randomly assigning labeled feature data of individual features from the resource data to either the training data set or the testing data set. In an example, the assignment of the labeled feature data of individual features may not be completely random. In an example, only the labeled feature data for a specific study may be used to generate the training data set and the testing data set. In an example, a majority of the labeled feature data for the specific study may be used to generate the training data set. For example, 75% of the labeled feature data for the specific study may be used to generate the training data set and 25% may be used to generate the testing data set. In an example, only the labeled feature data for the specific study may be used to generate the training data set and the testing data set.

The training method 500 may determine (e.g., extract, select, etc.), at 530, one or more features that can be used by, for example, a classifier to differentiate among different classifications (e.g., number of equipment outages and/or different classifications of equipment outages). The one or more features may comprise a group of resource data sets such as a group of resource characteristics or a group of weather data characteristics and equipment data characteristics. In an example, the training method 500 may determine a set of features from the resource data. In an example, a set of features may be determined from resource data from a study different than the study associated with the labeled feature data of the training data set and the testing data set. In other words, the resource data from the different study (e.g., curated resource data sets) may be used for feature determination, rather than for training a machine learning model. In an example, the training data set may be used in conjunction with the resource data from the different study to determine the one or more features. The resource data from the different study may be used to determine an initial set of features, which may be further reduced using the training data set.

The training method 500 may train one or more machine learning models using the one or more features at 540. As an example, the machine learning models may be trained using supervised learning. As an example, other machine learning techniques may be employed, including unsupervised learning and semi-supervised. The machine learning models trained at 540 may be selected based on different criteria depending on the problem to be solved and/or data available in the training data set. For example, machine learning classifiers can suffer from different degrees of bias. Accordingly, more than one machine learning model may be trained at 540, optimized, improved, and cross-validated at 550. For example, an automatic recognition model/algorithm may be used to determine the final machine learning model based on a plurality of machine learning models. For example, an equipment outage prediction may be determined based on each machine learning-based classification model. The final machine learning model may be determined based on the model with the most accurate prediction of the previous weather event.

The training method 500 may select one or more machine learning models to build a predictive model at 560 (e.g., a machine learning classifier). The predictive model may be evaluated using the testing data set. The predictive model may analyze the testing data set and generate classification values and/or predicted values at 570. Classification and/or prediction values may be evaluated at 580 to determine whether such values have achieved a desired accuracy level. Performance of the predictive model may be evaluated in a number of ways based on a number of true positive, false positive, true negative, and/or false negative classifications of the plurality of data points indicated by the predictive model. For example, the false positives of the predictive model may refer to a number of times the predictive model incorrectly classified a number of equipment outages based on the resource data. Conversely, the false negatives of the predictive model may refer to a number of times the machine learning model determined that a number of equipment outages or a range of a number of equipment outages were not associated with the resource data when, in fact, the resource data was associated with the number of equipment outages or the range of the number of equipment outages. True negatives and true positives may refer to a number of times the predictive model correctly classified a number of equipment outages based on the resource data. Related to these measurements are the concepts of recall and precision. Generally, recall refers to a ratio of true positives to a sum of true positives and false negatives, which quantifies a sensitivity of the predictive model. Similarly, precision refers to a ratio of true positives and a sum of true and false positives.

When a desired accuracy level is reached, the training phase ends and the predictive model may be output at 590; when the desired accuracy level is not reached, however, then a subsequent iteration of the training method 500 may be performed starting at 510 with variations such as, for example, considering a larger collection of resource data.

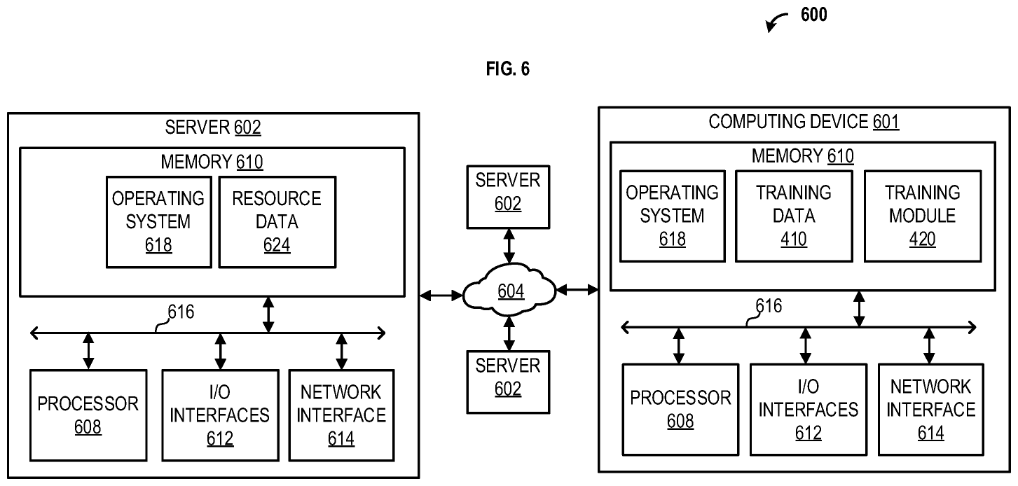

FIG. 6 shows an example computer system 600 for determining a number of equipment outages based on resource data associated with weather data and equipment data. For example, system 600 may comprise a computing device 601 and a server 602 connected via a network 604. In an example, some or all steps of any described method may be performed on a computing device as described herein. The computing device 601 may comprise one or more computers configured to store one or more of the training module 420, training data 410 (e.g., resource data and/or labeled baseline feature data), and the like. The server 602 may comprise one or more computers configured to store the resource data 624. One or more servers 602 may communicate with the computing device 601 via the network 604.

The computing device 601 and the server 602 may comprise a digital computer, wherein the digital computer may comprise a processor 608, memory system 610, one or more input/output (I/O) interfaces 612, and one or more network interfaces 614. In an example, the computing device 601 may comprise one or more of a smartphone, a mobile device, a smartwatch, a tablet computer, or a desktop computer. The processor 608, the memory system 610, the one or more input/output (I/O) interfaces 612, and the one or more network interfaces 614 may be in communication with each other via a local interface 616. The local interface 616 may comprise one or more buses or other wired or wireless connections. The local interface 616 may comprise additional elements, which are omitted for simplicity, such as controllers, buffers (caches), drivers, repeaters, and receivers, to enable communications. The local interface 616 may further include address, control, and/or data connections to enable appropriate communications among the processor 608, the memory system 610, the one or more input/output (I/O) interfaces 612, and the one or more network interfaces 614.

The processor 608 may be a hardware device for executing software, particularly that may be stored in memory system 610. The processor 608 may be any custom made or commercially available processor, a central processing unit (CPU), an auxiliary processor among several processors associated with the computing device 601 and the server 602, a semiconductor-based microprocessor (in the form of a microchip or chip set), or generally any device for executing software instructions. When the computing device 601 and/or the server 602 is in operation, the processor 608 may be configured to execute software stored within the memory system 610, to communicate data to and from the memory system 610, and to generally control operations of the computing device 601 and the server 602 pursuant to the software.

The one or more I/O interfaces 612 may comprise one or more interfaces for receiving user input from, and/or for providing system output to, one or more devices or components. User input may be provided via, for example, a keyboard and/or a mouse. System output may be provided via a display device and a printer (not shown). I/O interfaces 612 may include, for example, a serial port, a parallel port, a Small Computer System Interface (SCSI), an infrared (IR) interface, a radio frequency (RF) interface, and/or a universal serial bus (USB) interface.

The one or more network interfaces 614 may be used to transmit and receive data from the computing device 601 and/or the server 602 on the network 604. The network interface 614 may include, for example, a 10BaseT Ethernet Adaptor, a 100BaseT Ethernet Adaptor, a LAN PHY Ethernet Adaptor, a Token Ring Adaptor, a wireless network adapter (e.g., WiFi, cellular, satellite), or any other suitable network interface device. The one or more network interfaces 614 may include address, control, and/or data connections to enable appropriate communications on the network 604.

The memory system 610 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 610 may incorporate electronic, magnetic, optical, and/or other types of storage media. Note that the memory system 610 may have a distributed architecture, wherein various components are situated remote from one another, but may be accessed by the processor 608.

The software in the memory system 610 may include one or more software programs, each of which comprises an ordered listing of executable instructions for implementing logical functions. The software in the memory system 610 of the computing device 601 may comprise the training module 420 (or subcomponents thereof), the training data 410, and a suitable operating system (O/S) 618. The software in the memory system 610 of the server 602 may comprise, the resource data 624 and a suitable operating system (O/S) 618. The operating system 618 may control the execution of other computer programs and provide scheduling, input-output control, file and data management, memory management, and communication control, and related services.

As shown in FIG. 6, application programs and other executable program components, such as the operating system 618, are depicted as discrete blocks. However, it is recognized that such programs and components may reside at various times in different storage components of the computing device 601 and/or the server 602. As an example, the training module 420 may be stored on or transmitted across some form of computer readable media. Any of the disclosed methods may be performed by computer readable instructions embodied on computer readable media. Computer readable media may be any available media that can be accessed by a computer. For example, computer readable media may comprise “computer storage media” and “communications media.” “Computer storage media” may comprise volatile and non-volatile, removable and non-removable media implemented in any method or technology for storage of information such as computer readable instructions, data structures, program modules, or other data. In an example, computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

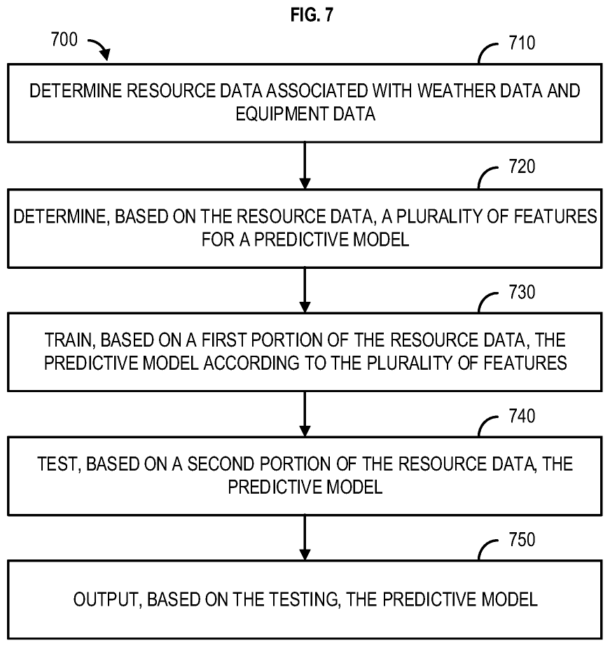

FIG. 7 shows a flowchart of an example method 700. The method 700 may be implemented in whole, or in part, by computing device 601, server 602, or any other suitable device. For example, method 700 may be implemented in whole, or in part, by the training model 420. At step 710, resource data associated with weather data and equipment data may be determined. For example, the resource data may comprise one or more groups of resource characteristics. The one or more groups of resource characteristics may be labeled according to a predefined feature of a plurality of predefined features. The weather data may comprise a storm classifier indicative of a windstorm, a thunderstorm, a hurricane, a cyclone, a blizzard, an ice storm, or a snow storm. The storm classifier may be associated with one or more storm characteristics of max winds, max gusts, lightning, max rain, max snow, max temp, min temp, average temp, or an affected geographic area. The equipment data may comprise data indicative of one or more equipment components in a geographic area associated with the weather data. The plurality of predefined features may comprise a plurality of characteristics associated with the equipment data. The plurality of characteristics associated with the equipment data may comprise one or more of electrical service equipment, gas service equipment, water service equipment, or telecommunication service equipment.

In an example, the resource data may be received from a public data source. As an example, determining the resource data may comprise determining, based on the weather data and the equipment data, one or more resource data sets that comprise one or more groups of one or more weather data characteristics and one or more equipment data characteristics, and generating, based on the one or more resource data sets, the resource data. As an example, determining the resource data may comprise determining baseline feature levels for each group of resource characteristics of the one or more groups of resource characteristics, labeling the baseline feature levels for each group of resource characteristics of the one or more groups of resource characteristics as at least one predefined feature of the plurality of predefined features, and generating, based on the labeled baseline feature levels, the resource data.

At step 720, a plurality of features for a predictive model may be determined based on the resource data. For example, determining the plurality of features for the predictive model may comprise determining, from the resource data, features present in two or more resource data sets of a plurality of resource data sets as a first set of candidate resource characteristics, determining, from the resource data, features of the first set of candidate resource characteristics that satisfy a first threshold score as a second set of candidate resource characteristics, and determining, from the resource data, features of the second set of candidate resource characteristics that satisfy a second threshold score as a third set of candidate resource characteristics, wherein the plurality of features comprises the third set of candidate resource characteristics. In an example, determining the plurality of features for the predictive model may comprise determining, for the third set of candidate resource characteristics, a feature score for each resource characteristic of a plurality of resource characteristics associated with the third set of candidate resource characteristics, determining, based on the feature score, a fourth set of candidate resource characteristics, wherein the plurality of features comprises the fourth set of candidate resource characteristics.

At step 730, the predictive model may be trained, based on a first portion of the resource data, according to the plurality of features. For example, training, based on the first portion of the resource data, the predictive model according to the plurality of features may comprise, or result in, determining a feature signature indicative of at least one predefined feature of the plurality of predefined features. At step 740, the predictive model may be tested based on a second portion of the resource data.

At step 750, the predictive model may be output based on the testing. The predictive model may be configured to output a prediction indicative of a number of equipment outages associated with a geographic area affected by a weather event. In an example, the prediction may be used to enable a utility/service provider to take proactive measures to optimize crews and asset resources to minimize the damages caused to the equipment in the geographic area affected by the weather event. For example, the proactive measures may comprise crew positioning, an optimal number of crews or crew members (e.g., field technicians), asset positioning (e.g., trucks, service drones), or positioning of mobile generations. The ability to efficiently predict equipment outages due to one or more weather events can minimize recovery operational costs and restoration time of services affected by the one or more equipment outages. This increases the resilience of the affected areas through more accurate planning and a more accurate estimation of the time to restoration.

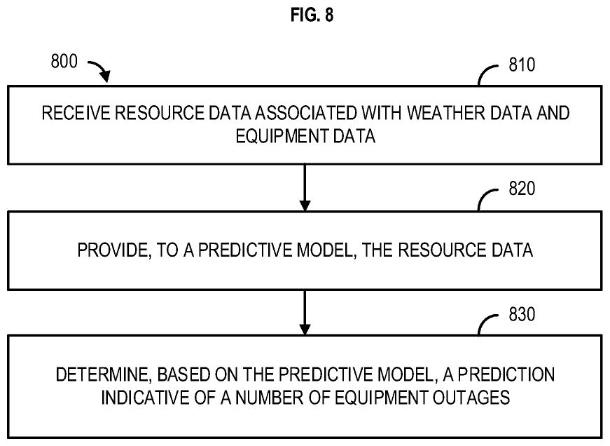

FIG. 8 shows a flowchart of an example method 800. The method 800 may be implemented in whole, or in part, by computing device 601, server 602, or any other suitable device. For example, method 800 may be implemented in whole, or in part, by the training model 420. At step 810, resource data associated with weather data and equipment data may be received. The weather data may be associated with a weather event affecting a geographic area. For example, the weather data may comprise a storm classifier indicative of a windstorm, a thunderstorm, a hurricane, a cyclone, a blizzard, an ice storm, or a snow storm. The storm classifier may be associated with one or more storm characteristics of max winds, max gusts, lightning, max rain, max snow, max temp, min temp, average temp, or an affected geographic area. The equipment data may be associated with one or more equipment components in the geographic data. In an example, the equipment data may comprise data indicative of a plurality of characteristics associated with the equipment data, such as electrical service equipment, gas service equipment, water service equipment, or telecommunication service equipment.

At step 820, the resource data may be provided to a predictive model. At step 830, a prediction indicative of a number of equipment outages associated with the geographic area affected by the weather event may be determined based on the predictive model. In an example, the prediction may be used to enable a utility/service provider to take proactive measures to optimize crews and asset resources to minimize the damages caused to the equipment in the geographical area affected by the weather event. For example, the proactive measures may comprise crew positioning, an optimal number of crews or crew members (e.g., field technicians), asset positioning (e.g., trucks, service drones), or positioning of mobile generations. The ability to efficiently predict equipment outages due to one or more weather events can minimize recovery operational costs and restoration time of services affected by the one or more equipment outages. This increases the resilience of the affected areas through more accurate planning and a more accurate estimation of the time to restoration.

Method 800 may further comprise training the predictive model. For example, determining, by a computing device, resource data associated with weather data and equipment data, wherein the resource data comprises one or more groups of resource characteristics, wherein each group of resource characteristics of the one or more groups of resource characteristics is labeled according to a predefined feature of a plurality of predefined features, determining, based on the resource data, a plurality of features for the predictive model, training, based on a first portion of the resource data, the predictive model according to the plurality of features, testing, based on a second portion of the resource data, the predictive model, and outputting, based on the testing, the predictive model.

As an example, the plurality of predefined features may comprise a plurality of characteristics associated with the equipment data. As an example, the plurality of predefined features may comprise one or more of electrical service equipment, gas service equipment, water service equipment, or telecommunication service equipment.

In an example, the resource data may be received from a public data source. As an example, determining the resource data may comprise determining, based on the weather data and the equipment data, one or more resource data sets that comprise one or more groups of one or more weather data characteristics and one or more equipment data characteristics, and generating, based on the one or more resource data sets, the resource data. As an example, determining the resource data may comprise determining baseline feature levels for each group of resource characteristics of the one or more groups of resource characteristics, labeling the baseline feature levels for each group of resource characteristics of the one or more groups of resource characteristics as at least one predefined feature of the plurality of predefined features, and generating, based on the labeled baseline feature levels, the resource data.

Determining the plurality of features for the predictive model based on the resource data may comprise determining, from the resource data, features present in two or more resource data sets of a plurality of resource data sets as a first set of candidate resource characteristics, determining, from the resource data, features of the first set of candidate resource characteristics that satisfy a first threshold score as a second set of candidate resource characteristics, and determining, from the resource data, features of the second set of candidate resource characteristics that satisfy a second threshold score as a third set of candidate resource characteristics, wherein the plurality of features comprises the third set of candidate resource characteristics. In an example, determining the plurality of features for the predictive model based on the resource data may comprise determining, for the third set of candidate resource characteristics, a feature score for each resource characteristic of a plurality of resource characteristics associated with the third set of candidate resource characteristics, and determining, based on the feature score, a fourth set of candidate resource characteristics, wherein the plurality of features comprises the fourth set of candidate resource characteristics.

Training, based on the first portion of the resource data, the predictive model according to the plurality of features may comprise, or result in, determining signature indicative of at least one predefined feature of the plurality of predefined features.

Embodiment 1: A method comprising: determining, by a computing device, resource data associated with weather data and equipment data, wherein the resource data comprises one or more groups of resource characteristics, wherein each group of resource characteristics of the one or more groups of resource characteristics is labeled according to a predefined feature of a plurality of predefined features, determining, based on the resource data, a plurality of features for a predictive model, training, based on a first portion of the resource data, the predictive model according to the plurality of features, testing, based on a second portion of the resource data, the predictive model, and outputting, based on the testing, the predictive model.

Embodiment 2: The embodiment as in any one of the preceding embodiments wherein the weather data comprises a storm classifier indicative of a windstorm, a thunderstorm, a hurricane, a cyclone, a blizzard, an ice storm, or a snow storm.

Embodiment 3: The embodiment as in embodiment 2, wherein the storm classifier is associated with one or more storm characteristics of max winds, max gusts, lightning, max rain, max snow, max temp, min temp, average temp, or an affected geographic area.

Embodiment 4: The embodiment as in any one of the preceding embodiments wherein the equipment data comprises data indicative of one or more equipment components in a geographic area associated with the weather data.

Embodiment 5: The embodiment as in any one of the preceding embodiments wherein the plurality of predefined features comprises a plurality of characteristics associated with the equipment data.

Embodiment 6: The embodiment as in any one of the preceding embodiments wherein the plurality of characteristics comprise one or more of electrical service equipment, gas service equipment, water service equipment, or telecommunication service equipment.

Embodiment 7: The embodiment as in any one of the preceding embodiments wherein determining the resource data comprises receiving the resource data from a public data source.

Embodiment 8: The embodiment as in any one of the preceding embodiments wherein determining the resource data comprises determining, based on the weather data and the equipment data, one or more resource data sets that comprise one or more groups of one or more weather data characteristics and one or more equipment data characteristics, and generating, based on the one or more resource data sets, the resource data.

Embodiment 9: The embodiment as in any one of the preceding embodiments wherein determining the resource data comprises determining baseline feature levels for each group of resource characteristics of the one or more groups of resource characteristics, labeling the baseline feature levels for each group of resource characteristics of the one or more groups of resource characteristics as at least one predefined feature of the plurality of predefined features, and generating, based on the labeled baseline feature levels, the resource data.

Embodiment 10: The embodiment as in any one of the preceding embodiments wherein determining, based on the resource data, the plurality of features for the predictive model comprises determining, from the resource data, features present in two or more resource data sets of a plurality of resource data sets as a first set of candidate resource characteristics, determining, from the resource data, features of the first set of candidate resource characteristics that satisfy a first threshold score as a second set of candidate resource characteristics, and determining, from the resource data, features of the second set of candidate resource characteristics that satisfy a second threshold score as a third set of candidate resource characteristics, wherein the plurality of features comprises the third set of candidate resource characteristics.

Embodiment 11: The embodiment as in embodiment 9 wherein determining, based on the resource data, the plurality of features for the predictive model comprises determining, for the third set of candidate resource characteristics, a feature score for each resource characteristic of a plurality of resource characteristics associated with the third set of candidate resource characteristics, and determining, based on the feature score, a fourth set of candidate resource characteristics, wherein the plurality of features comprises the fourth set of candidate resource characteristics.

Embodiment 12: The embodiment as in any one of the preceding embodiments wherein training, based on the first portion of the resource data, the predictive model according to the plurality of features results in determining a feature signature indicative of at least one predefined feature of the plurality of predefined features.

Embodiment 13: The embodiment as in any one of the preceding embodiments wherein the predictive model is configured to output a prediction indicative of a number of equipment outages associated with a geographic area.

Embodiment 14: The embodiment as in embodiment 13 further comprising deploying, based on the prediction, one or more asset resources to the geographic area.

Embodiment 15: A method comprising: receiving, at a computing device, resource data associated with weather data associated with a weather event affecting a geographic area and equipment data associated with one or more equipment components in the geographic area, providing, to a predictive model, the resource data, and determining, based on the predictive model, a prediction indicative of a number of equipment outages associated with the geographic area.

Embodiment 16: The embodiment as in the embodiment 15 wherein the weather data comprises a storm classifier indicative of a windstorm, a thunderstorm, a hurricane, a cyclone, a blizzard, an ice storm, or a snow storm.

Embodiment 17: The embodiment as in the embodiment 16 wherein the storm classifier is associated with one or more of storm characteristics of max winds, max gusts, lightning, max rain, max snow, max temp, min temp, average temp, or an affected geographic area.

Embodiment 18: The embodiment as in the embodiments 15-17 wherein the equipment data comprises data indicative of the one or more equipment components in the geographic area.

Embodiment 19: The embodiment as in the embodiments 15-18 further comprising deploying, based on the prediction, one or more asset resources to the geographic area.

Embodiment 20: The embodiment as in the embodiments 15-19 further comprising training the predictive model.

Embodiment 21: The embodiment as in the embodiment 20 wherein training the predictive model comprises determining the resource data associated with the weather data and the equipment data, wherein the resource data comprises one or more groups of resource characteristics, wherein each group of resource characteristics of the one or more groups of resource characteristics is labeled according to a predefined feature of a plurality of predefined features, determining, based on the resource data, a plurality of features for the predictive model, training, based on a first portion of the resource data, the predictive model according to the plurality of features, testing, based on a second portion of the resource data, the predictive model, and outputting, based on the testing, the predictive model.

Embodiment 22: The embodiment as in the embodiment 21 wherein the plurality of predefined features comprises a plurality of characteristics associated with the equipment data.

Embodiment 23: The embodiment as in the embodiment 22 wherein the plurality of characteristics comprise one or more of electrical service equipment, gas service equipment, water service equipment, or telecommunication service equipment.

Embodiment 24: The embodiment as in the embodiments 21-23 wherein determining the resource data comprises determining, based on the weather data and the equipment data, one or more resource data sets that comprise one or more groups of one or more weather data characteristics and one or more equipment data characteristics, and generating, based on the one or more resource data sets, the resource data.

Embodiment 25: The embodiment as in the embodiments 21-24 wherein determining the resource data comprises determining baseline feature levels for each group of resource characteristics of the one or more groups of resource characteristics, labeling the baseline feature levels for each group of resource characteristics of the one or more groups of resource characteristics as at least one predefined feature of the plurality of predefined features, and generating, based on the labeled baseline feature levels, the resource data.

Embodiment 26: The embodiment as in the embodiments 21-25 wherein determining, based on the resource data, the plurality of features for the predictive model comprises determining, from the resource data, features present in two or more resource data sets of a plurality of resource data sets as a first set of candidate resource characteristics, determining, from the resource data, features of the first set of candidate resource characteristics that satisfy a first threshold score as a second set of candidate resource characteristics, and determining, from the resource data, features of the second set of candidate resource characteristics that satisfy a second threshold score as a third set of candidate resource characteristics, wherein the plurality of features comprises the third set of candidate resource characteristics.

Embodiment 27: The embodiment as in the embodiment 26 wherein determining, based on the resource data, the plurality of features for the predictive model comprises determining, for the third set of candidate resource characteristics, a feature score for each resource characteristic of a plurality of resource characteristics associated with the third set of candidate resource characteristics, and determining, based on the feature score, a fourth set of candidate resource characteristics, wherein the plurality of features comprises the fourth set of candidate resource characteristics.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
determining, by a computing device, resource data associated with weather data and equipment data, wherein the resource data comprises one or more groups of resource characteristics, wherein each group of resource characteristics of the one or more groups of resource characteristics is labeled according to a predefined feature of a plurality of predefined features;
determining, based on the resource data, a plurality of features for a predictive model;
training, based on a first portion of the resource data, the predictive model according to the plurality of features;
testing, based on a second portion of the resource data, the predictive model; and
outputting, based on the testing, the predictive model.

2. The method of claim 1, wherein the weather data comprises a storm classifier indicative of a windstorm, a thunderstorm, a hurricane, a cyclone, a blizzard, an ice storm, or a snow storm.

3. The method of claim 2, wherein the storm classifier is associated with one or more storm characteristics of max winds, max gusts, lightning, max rain, max snow, max temp, min temp, average temp, or an affected geographic area.

4. The method of claim 1, wherein the equipment data comprises data indicative of one or more equipment components in a geographic area associated with the weather data.

5. The method of claim 1, wherein determining the resource data comprises:
determining, based on the weather data and the equipment data, one or more resource data sets that comprise one or more groups of one or more weather data characteristics and one or more equipment data characteristics; and
generating, based on the one or more resource data sets, the resource data.

6. The method of claim 1, wherein determining the resource data comprises:
determining baseline feature levels for each group of resource characteristics of the one or more groups of resource characteristics;
labeling the baseline feature levels for each group of resource characteristics of the one or more groups of resource characteristics as at least one predefined feature of the plurality of predefined features; and
generating, based on the labeled baseline feature levels, the resource data.

7. The method of claim 1, wherein determining, based on the resource data, the plurality of features for the predictive model comprises:
determining, from the resource data, features present in two or more resource data sets of a plurality of resource data sets as a first set of candidate resource characteristics;
determining, from the resource data, features of the first set of candidate resource characteristics that satisfy a first threshold score as a second set of candidate resource characteristics; and
determining, from the resource data, features of the second set of candidate resource characteristics that satisfy a second threshold score as a third set of candidate resource characteristics,
wherein the plurality of features comprises the third set of candidate resource characteristics.

8. The method of claim 7, wherein determining, based on the resource data, the plurality of features for the predictive model comprises:
determining, for the third set of candidate resource characteristics, a feature score for each resource characteristic of a plurality of resource characteristics associated with the third set of candidate resource characteristics; and
determining, based on the feature score, a fourth set of candidate resource characteristics,
wherein the plurality of features comprises the fourth set of candidate resource characteristics.

9. The method of claim 1, wherein training, based on the first portion of the resource data, the predictive model according to the plurality of features results in determining a feature signature indicative of at least one predefined feature of the plurality of predefined features.

10. The method of claim 1, wherein the predictive model is configured to output a prediction indicative of a number of equipment outages associated with a geographic area.

11. A method comprising:
receiving, at a computing device, resource data associated with weather data associated with a weather event affecting a geographic area and equipment data associated with one or more equipment components in the geographic area;
providing, to a predictive model, the resource data; and
determining, based on the predictive model, a prediction indicative of a number of equipment outages associated with the geographic area.

12. The method of claim 11, wherein the weather data comprises a storm classifier indicative of a windstorm, a thunderstorm, a hurricane, a cyclone, a blizzard, an ice storm, or a snow storm.

13. The method of claim 12, wherein the storm classifier is associated with one or more of storm characteristics of max winds, max gusts, lightning, max rain, max snow, max temp, min temp, average temp, or an affected geographic area.

14. The method of claim 11, wherein the equipment data comprises data indicative of the one or more equipment components in the geographic area.

15. The method of claim 11, further comprising deploying, based on the prediction, one or more asset resources to the geographic area.

16. The method of claim 11, further comprising training the predictive model.

17. The method of claim 16, wherein training the predictive model comprises:
determining the resource data associated with the weather data and the equipment data, wherein the resource data comprises one or more groups of resource characteristics, wherein each group of resource characteristics of the one or more groups of resource characteristics is labeled according to a predefined feature of a plurality of predefined features;
determining, based on the resource data, a plurality of features for the predictive model;
training, based on a first portion of the resource data, the predictive model according to the plurality of features;
testing, based on a second portion of the resource data, the predictive model; and
outputting, based on the testing, the predictive model.

18. The method of claim 17, wherein determining the resource data comprises:
determining, based on the weather data and the equipment data, one or more resource data sets that comprise one or more groups of one or more weather data characteristics and one or more equipment data characteristics; and
generating, based on the one or more resource data sets, the resource data.

19. The method of claim 17, wherein determining the resource data comprises:
determining baseline feature levels for each group of resource characteristics of the one or more groups of resource characteristics;
labeling the baseline feature levels for each group of resource characteristics of the one or more groups of resource characteristics as at least one predefined feature of the plurality of predefined features; and
generating, based on the labeled baseline feature levels, the resource data.

20. The method of claim 17, wherein determining, based on the resource data, the plurality of features for the predictive model comprises:
determining, from the resource data, features present in two or more resource data sets of a plurality of resource data sets as a first set of candidate resource characteristics;
determining, from the resource data, features of the first set of candidate resource characteristics that satisfy a first threshold score as a second set of candidate resource characteristics; and
determining, from the resource data, features of the second set of candidate resource characteristics that satisfy a second threshold score as a third set of candidate resource characteristics,
wherein the plurality of features comprises the third set of candidate resource characteristics.
